(19) United States
(12) Patent Application Publication
(10) Pub. No.: US 2015/0227704 A1
(43) Pub. Date: Aug. 13, 2015

(54) Electronic Manifolds And Display Systems For Monitoring Delivery Of Contrast Media And Methods Of Using Same

(71) Applicant: Steven B. Laster, Olathe, KS (US)

(72) Inventor: Steven B. Laster, Olathe, KS (US)

(21) Appl. No.: 14/617,618

(22) Filed: Feb. 9, 2015

Related U.S. Application Data
(60) Provisional application No. 61/937,367, filed on Feb. 7, 2014.

(51) Int. Cl. G06F 19/00; G01F 22/00; H04L 29/08

(52) U.S. Cl. CPC G06F 19/3406; H04L 67/10; G01F 22/00

(57) ABSTRACT

Systems, methods and computer storage media for monitoring contrast media volume are disclosed. The system includes an electronic manifold having a processor in data communication with non-transitory computer memory, programming, an input device, and a first output device. The electronic manifold has a contrast media intake port and a volume sensor. The programming includes instructions for (a) receiving input of patient specific data and contrast media data; (b) calculating a patient's renal function; (c) determining at least one of a contrast volume target and a contrast volume limit based on the patient's renal function; (d) calculating the total volume of contrast media flowing through the manifold; and (e) displaying the contrast volume data on the first output device.

### CROSS-REFERENCE TO RELATED APPLICATIONS

This application claims priority to U.S. provisional patent application 61/937,367, filed Feb. 7, 2014, the disclosure of which is incorporated herein in its entirety by reference.

### BACKGROUND

Acute kidney injury (AKI) due to contrast induced nephropathy (CIN) is a common, serious complication of percutaneous coronary intervention (PCI). The incidence after PCI is 7.1% and the mortality is 9.7% in those patients affected. Over 500,000 PCIs are performed in the US each year. AKI is a major contributor to hospital costs and length of stay after PCI. Contrast induced AKI following PCI increases length of stay by an average of 7 days and adds on average an incremental cost per case in excess of $10,000. Reducing the incidence of AKI following PCI will lower patient morbidity and mortality and decrease the costs associated with PCI.

Although AKI can occur following contrast administration in patients with normal renal function, patients with chronic kidney disease (CKD) are at substantially higher risk for contrast induced acute kidney injury (CI-AKI). The incidence of CKD in the population is 25% overall and increases to 35% in the elderly.

Chronic kidney disease is generally underappreciated when renal function is assessed by serum creatinine measurements alone. Determination of a patient's estimated glomerular filtration rate (eGFR) using the Modification of Diet in Renal Disease (MDRD) equation or creatinine clearance (CrCl) using the Cockcroft-Gault (C-G) equation leads to a more accurate assessment of the patient's baseline renal function and individual risk of contrast-induced nephropathy. Currently, the National Kidney Foundation recommends the newer MDRD equation for evaluating progression of renal function and the older Cockcroft-Gault equation for dosing medications. The MDRD equation is a four variable equation requiring serum creatinine, age, race and gender:

$$eGFR ( \frac{\frac{ml}{min}}{1.73 {m}^{2}} ) = 175 * {SerumCr}^{- 1.154} * {age}^{- 0.203} * 1.21 ( if block ) * 0.742 ( if female )$$

The Cockcroft-Gault formula requires the serum creatinine, patient age and weight.

$$CrCl ( \frac{ml}{min} ) = \frac{( 140 - age ) * ( Wt ( in kg ) ) * ( 0.85 ( if female ) )}{72 * Cr ( \frac{mg}{dL} )}$$

There are two proven measures to minimize the nephrotoxicity of contrast dye: a) pre and post-procedural intravenous hydration with normal saline; and b) minimization of procedural contrast volume. The risk of CI-AKI is directly associated with increasing contrast volumes adjusted for renal function. The work of Gurm et. al., (J Am Card Cardiol 2011; 58: 907-14), demonstrated that the risk of CIN approaches significance if the contrast volume used during a procedure exceeds two times the value of the patient's calculated creatinine clearance and is dramatically elevated when it exceeds three times the CrCl (e.g., if patient's CrCl=50 ml/min, the recommended contrast limit is 100 ml, not to exceed 150 ml). More recently, Capodanno et. al. (Catheter Cardio Inte 83:907-912 (2014)) found that a volume to creatinine clearance ratio of ≧4 significantly predicts the risk of early postprocedural rise in serum creatinine. Assessment of risk for contrast-induced AKI and minimization of procedural contrast use are both American College of Cardiology/American Heart Association Class I indications. In addition to contrast volume and severe renal insufficiency, other clinical variables such as hypotension, congestive heart failure, advanced age, intra-aortic balloon pump use and ST elevation myocardial infarction increase the risk of CI-AKI. Several models exist to measure the risk of AKI based on clinical variables including those from Mehran et. al., (J Am Coll Cardiol. 2004; 44 (7):1393-1399), and Tsai et al. (JACC Cardiovasc Interv. 2014 January; 7(1):1-9), the later from the National Cardiovascular Data Registry (NCDR) CathPCI database. Based on patient specific risk of post-procedural AKI and dialysis, these models can set a procedural contrast limit below that for which the risk of AKI is very low.

Cardiac catheterization laboratory (or “cath lab”) contrast volume measurements using a traditional manual manifold and methods of are measurement are unreliable and inaccurate. Estimates of contrast volume use with manual manifolds are obtained using the hash marks present on commercial contrast media bottles and are often off by 25 to 50 ml of contrast. Contrast “waste” in the line must also be estimated, presenting yet another source of error to the process. Most importantly, real time procedural contrast volume measurements are not available to the interventionalist, as measurements are typically obtained only at the completion of the procedure. Furthermore, it is not uncommon for the operator performing the angiographic procedure to be unaware of the extent of their patient's renal insufficiency and the recommended procedural contrast targets or limits. Accurate real time measurement of contrast volume use relative to a patient specific contrast volume target or limit could lead to procedural modifications that reduce the total case contrast dose, patient complications, and unnecessary costs. Automated contrast power injectors can provide real time, accurate information on delivered contrast volume but require a more complicated set up, a large capital investment and higher per procedural disposable costs, and are far less frequently used than manual manifolds.

A device is therefore needed outside of automated injectors to more accurately measure procedural contrast use and provide contrast use indication to an interventionalist in real time. A healthcare institution may also benefit from data on the use of contrast media which may be used to modify and reduce institution-wide and physician-specific use of contrast media. Such a device, in combination with a presentation of patient specific contrast volume targets or limits will encourage procedural reductions in contrast use, reducing the likelihood of incidence of CI-AKI following PCI and other angiographic procedures.

### SUMMARY OF THE INVENTION

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented below.

Systems for monitoring contrast media volume are disclosed. In one embodiment, the system includes an electronic manifold having a processor in data communication with non-transitory computer memory, programming, an input device, and a first output device. The electronic manifold has a contrast media intake port and a volume sensor. The programming includes instructions for (a) receiving input of patient specific data and contrast media data; (b) calculating a patient's renal function; (c) determining at least one of a contrast volume target and a contrast volume limit based on the patient's renal function; (d) calculating the total volume of contrast media flowing through the manifold; and (e) displaying the contrast volume data on the first output device.

In another embodiment, a system for measuring an amount of delivered contrast media volume to a patient, includes a manifold, an electronic manifold attachment removably attached to the manifold, and an input device in communication with the electronic manifold attachment. The electronic manifold attachment has a flow meter; and an electronic element having a processor; non-transitory computer memory; and programming. The flow meter measures the flow rate of contrast media through the manifold during a procedure. And the programming includes instructions for: (a) calculating a patient's estimated renal function based on patient specific data input; (b) determining a contrast volume target and a contrast volume limit based on the patient's estimated renal function; (c) calculating the total volume of contrast through the manifold based on the flow rate; and (d)

displaying the volume of fluid through the manifold, the contrast volume target, and the contrast volume limit.

In still another embodiment, a system for measuring contrast media volume comprises a manifold with a volume sensor attached thereto, an input device, and an output device. The input device and the output device are in communication with the volume sensor. Patient specific data is entered into the system via the input device and displayed via the output device. The volume sensor determines the volume of contrast media through the manifold; and the volume of contrast delivered to the patient is displayed on the output device against a predetermined target amount of contrast media for the patient.

### BRIEF DESCRIPTION OF THE DRAWINGS

FIG. 1 illustrates a prior art manual manifold.

FIG. 2 is a system diagram of the invention according to one embodiment.

FIG. 3 is a diagram of an electronic manifold with sensors and a display screen and display unit according to one embodiment.

FIG. 4 is a front view of an electronic manifold with volume sensor and display screen according to one embodiment.

FIG. 5 is a front view of a contrast monitoring and contrast gauge display screen.

FIG. 6 is a diagram of an electronic manifold with volume sensor and a display unit according to another embodiment.

FIG. 7a-7c are front views of a standard manifold with an electronic manifold attachment attached to the manifold according to embodiments of the invention.

FIG. 8 is a schematic diagram showing an electronic manifold screen sequence for the input of patient-specific data and contrast media type and the display of the contrast monitoring screen.

FIG. 9 is another schematic diagram showing the monitor display sequence for input of patient-specific data and contrast media type and display of the contrast gauge screen.

FIG. 10 is a schematic diagram of an electronic manifold volume sensor.

FIG. 11 is a schematic diagram of a cardiac catheterization laboratory configuration including an electronic manifold, handheld electronic device, monitor display unit, cath lab monitors, and catheterization lab hemodynamic monitoring and reporting system.

### WRITTEN DESCRIPTION

Electronic manifolds and monitor display systems for the real time measurement and monitoring of the administration of contrast media and accompanying methods of use are disclosed herein. The manifold and monitor display system may be used, for example, during angiographic and interventional procedures. In an embodiment, the system comprises a manifold, means for measuring delivered contrast media volume in real time, and means for displaying the delivered contrast media volume in real time to permit and encourage the real time monitoring of contrast media administration relative to contrast dose limits recommended for an individual patient's renal function.

Traditionally, the volume of contrast delivered to a patient is based on primitive methods that include marking the volume on the contrast bottle at the start and ending points of the procedure and estimating the amount of contrast “waste” remaining in the tubing and contrast reservoir at the end of the procedure which, combined, at best, provide an approximation of the amount of contrast actually delivered to the patient. Thus, the determination of the amount of contrast delivered to a patient only occurs post-procedure. This does not allow the operator to routinely assess the amount of contrast delivered to the patient during the procedure to ensure compliance with the targets and limits of contrast set for the particular patient or make modifications in the procedure to limit the contrast dose.

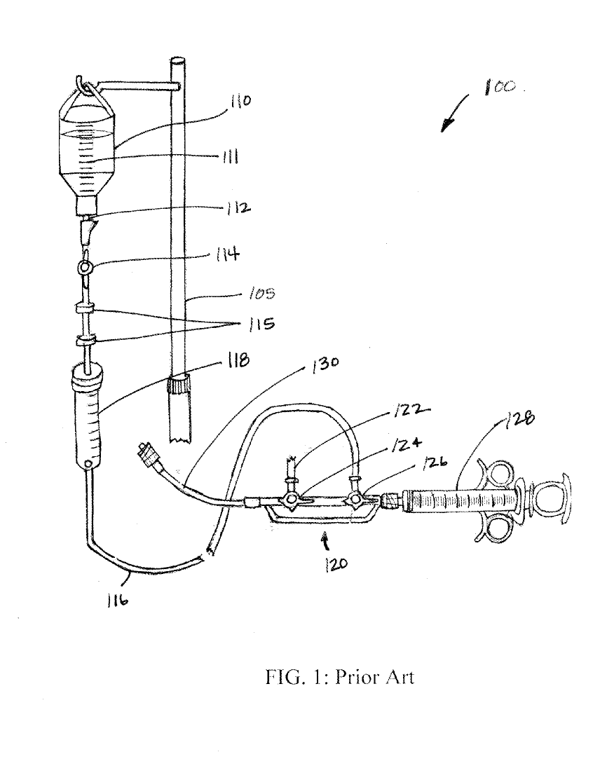

FIG. 1 depicts a prior art contrast delivery system 100. A contrast bottle 110, typically 200 ml in volume (though other sized bottles may also be used), is spiked with a bottle spike 112 and hung from an IV pole 105. The contrast bottle has volume markers 111 in 25 ml increments displayed on the side of the bottle that may be used to measure procedural contrast use. If a bottle is not new, and a portion of the contrast in the bottle has been used on a previous case, the starting level of contrast for a procedure may be marked on the bottle. A contrast spike 112 and stopcock 114 are connected to inflow tubing 116 and a contrast “saver” reservoir 118. Contrast is pulled from a manifold 120 via valves 115 into the contrast reservoir 118. The reservoir 118 diminishes the likelihood of air bubbles getting into the system and also allows the contrast remaining in the bottle to be used on subsequent cases, as the reservoir 118 and tubing 116 are discarded after use. Intravenous saline, under pressure from an arterial line set-up, is flushed in tubing 122 to a first stopcock 124. Pressure transmitted via the catheter to the manifold can therefore be measured when the stopcock 124 is turned open to the pressure transducer. Other manifold configurations may be possible, with a separate port for waste to be expelled and separate ports each for saline flush and hemodynamic monitoring).

Contrast is pulled from the reservoir 118 by a control syringe 128 via the second stopcock 126 into the syringe 128. Injections of contrast (e.g., for the purpose of angiographic imaging) are then made with the control syringe via the manifold 118 and tubing 130 to the angiographic catheter (not shown). At the completion of the case, the level of contrast remaining in the bottle 110 is marked. By subtracting the ending volume in the bottle from the starting volume, the contrast dose for the case is determined.

Often, multiple bottles of contrast are used and these volumes need to be summed. The contrast “waste” remaining in the tubing and contrast “saver” reservoir 118 is estimated and subtracted from the total to more accurately reflect the dose actually delivered to the patient. The contrast dose is typically only measured after the completion of the case and not during the procedure. Inaccuracies may arise due to measurements made with the crude volumetric scale used on the contrast bottle, or due to human error such as failure to mark the contrast level at the start of a case or failure to account for all of the contrast bottles used during a case.

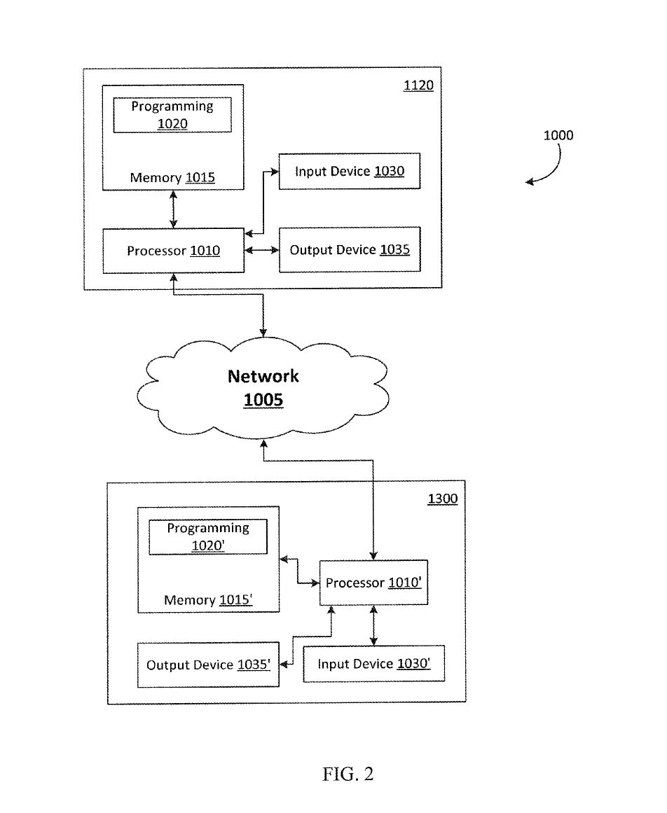

FIG. 2 illustrates a system 1000 for calculating and displaying contrast volume data according to one embodiment. The system may include at least one data unit 1120 and at least one display unit 1300. In some embodiments, the data unit 1120 and the display unit 1300 may be combined, and it shall be appreciated that various functionality may be supported by the data unit 1120 and/or the display unit 1300. The display unit 1300 may be a mounted monitor display 1300 which may include the necessary hardware (e.g., clips, adhesive, hangers, et cetera) for mounting the display to an IV pole 103 (FIG. 1) or other structural element.

In embodiments 1000, the data unit 1120 and display unit 1300 may each include a processor 1010, 1010′ in data communication with an input device 1030, 1030′, at least one output device 1035, 1035′, and non-transitory computer memory 1015, 1015′. The non-transitory computer memory 1015, 1015′ comprises at least one program 1020, 1020′ that may include instructions for calculating a patient's eGFR and/or CrCl and comparing it against the real time volume of contrast used.

As will be appreciated by those skilled in the art, the computer memory 1015 may consist of any appropriate computer-storage media (e.g., RAM, ROMEEPROM, flash memory, et cetera). A networking device 1025 of the data unit 1120 may be data communication with the processor 1010 to communicate with the display units 1300, and specifically with the display unit networking device 1025′. The networking devices 1025, 1025′ may be modem hardware that allows communication though the Internet or a local network, or any other appropriate communication technology, whether now known or later developed.

The input device 1030, 1030′, (e.g., one or more keyboards, microphones, touchscreens, et cetera) may be in data communication with the processor 1010, 1010′ to provide data from the user to the processor 1010, 1010′, and the output device 1035, 1035′ (e.g., visual display, speaker, et cetera) may be in data communication with the processor 1010, 1010′ for providing data from the processor 1010, 1010′ to the user. In some embodiments, a touchscreen may function as both the input device 1030, 1030′ and the output device 1035, 1035′. Additional input devices and/or output devices may additionally be included and may be embodied on one or more computing device.

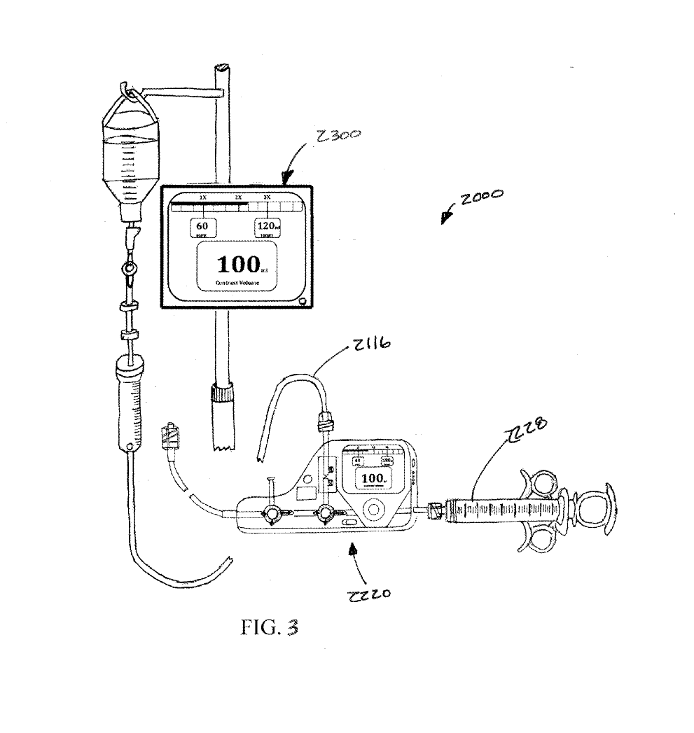

In one embodiment 2000, the data unit 1120 comprises an electronic manifold w220 as described below with reference to FIGS. 3-5. The electronic manifold 2220 may generally correspond in some aspects to manifold 120 (FIG. 1), except as shown and described herein or as would be understood by one of ordinary skill in the art. Therefore, corresponding reference numerals designate similar features between the manifolds 120, 2220 (e.g., stopcock 124 generally corresponds to stopcock 2224).

It should be noted that the manifold 2220 should generally maintain a similar contour and weight as traditional manifolds (e.g., 120) so as not to adversely disrupt or alter the angiographic or interventional procedure. Therefore, the manifold 2220 may be approximately the same length as a standard manifold, such as that shown in FIG. 1, but may be wider and slightly heavier. For example, the manifold 2220 may be approximately 16 cm in length, not including the tubing extending from the manifold 2220, and approximately 8 cm in width at its widest point. The manifold 2220 may be narrower at a point of saline intake 2222 unless, for example, electronic components require it to have additional width. The mechanics of stopcocks 2224, 2226 and the performance features for angiographic examinations may be unchanged compared with the prior art manifold 120 described above.

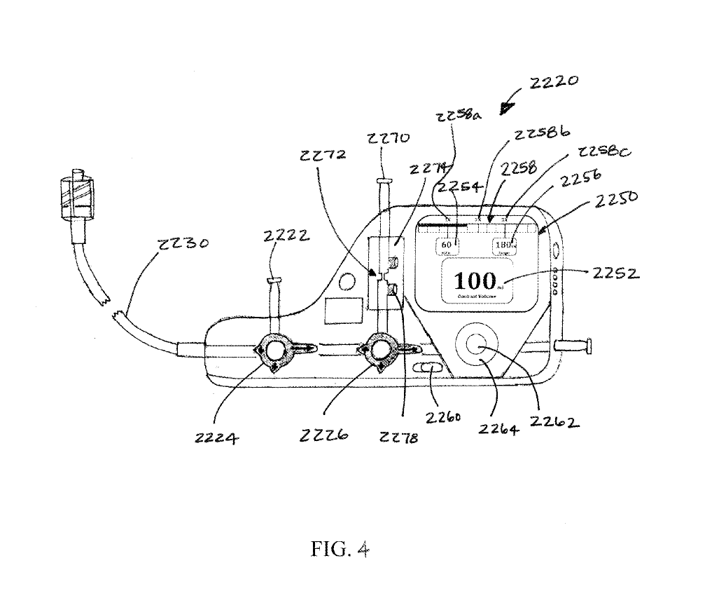

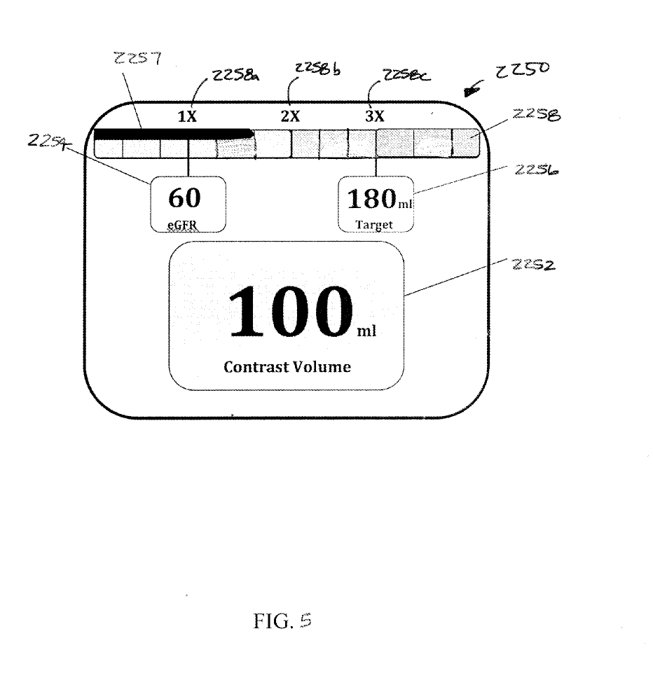

With reference to FIGS. 4 and 5, the electronic manifold 2220 may have a manifold display 2250. The manifold display 2250 may have separate displays for providing contrast volume data to the healthcare professionals in real time. For example, a numerical volume display 2252 may depict in mL the amount of contrast used for the patient. The patient's calculated eGFR, target contrast usage, and/or limit of contrast may also be displayed numerically as shown at displays 2254 and 2256 as shown in FIG. 4. Alternately, the display may include a graphical display such as a TFT, OLED, or LCD display, or LED indictors or moving indicators such as a dial indicator, gauge indicator, or moving mechanical display element.

Additionally, a graphical representation of the contrast usage may be provided as a contrast gauge 2258 on the manifold display 2250. Indications 2258a, 2258b, 2258c above the contrast gauge 2258 may correspond to the patient's determined eGFR (1× the patient's eGFR) 2258a, contrast target volume (2× the patient's eGFR) 2258b, and contrast limit volume (3× the patient's eGFR) 2258c, and a moving line 2257 may represent the total volume of contrast media in real time which may provide a visual tracking mechanism for evaluating contrast volume relative to the patient's limits. The displays 2254 and 2256 may be located directly under the 1× indication at 2258a and the 3× indication at 2258c as indications of the patient's determined eGFR and contrast limit volume.

The contrast gauge 2258 may be color coded for ease of recognition. For example, a volume between zero and 2× (2258b) may be green to provide visual recognition to the healthcare professional that the contrast volume is under the determined target amount. Between 2× (2258b) and 3× (2258c), the gauge 2258 may be yellow to provide a warning to the healthcare professional that the contrast volume is greater than the target and is approaching the patient's limit. When the contrast volume exceeds the patient's limit at 3× (2258c), the gauge may turn red. While the colors green, yellow, and red are generally understood to mean “good”, “warning”, and “stop”, respectively, and may therefore be preferable, it shall be understood that other colors may be used as well.

In addition to the color warnings, other warnings may be presented to the healthcare professional, including auditory alerts via speakers 2260 or haptic (vibratory) alerts when the target and/or limit is reached. Alternately, the manifold 2220 may be in communication with an external alarm monitor or external indicator to alert the healthcare professional when the target and/or limit is reached.

Additionally, as may be understood by those of skill in the art that it may be beneficial for the manifold display 2250 to be backlit in one or more colors that allows for ease of visibility in a dark lab environment. Common colors, although not required, are green and blue.

While the manifold display 2250 is described above in terms of the patient's eGFR, the display 2250 may also, or alternately, be modified to display the patient's contrast volume to CrCl ratio and corresponding targets (e.g., 2×CrCl) and limits (e.g., 3×CrCl). Additionally, the contrast limits may be set at other values, such as 4× the patient's eGFR or CrCl, or at a contrast volume limit based on the ACC-NCDR AKI model that further incorporates the patient's clinical characteristics in determining AKI risk. Alternately, a healthcare provider may input desired values for contrast use targets and/or limits.

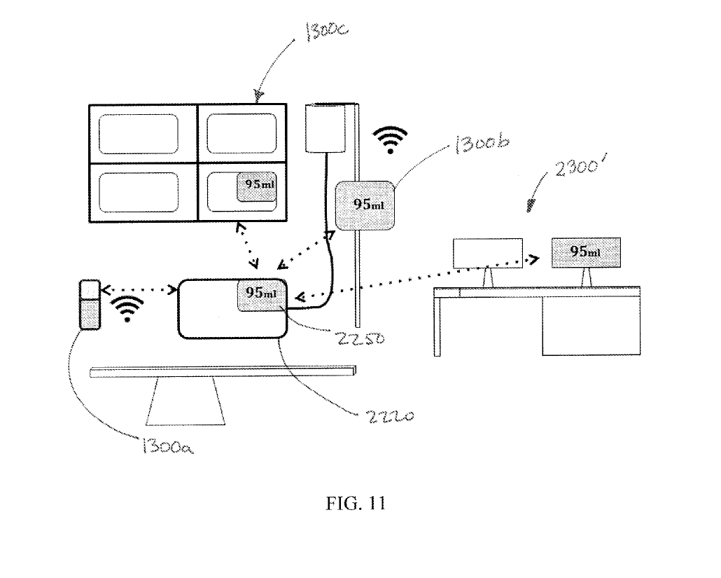

In addition to, or instead of, being displayed on the manifold display 2250, the contrast volume data may be transmitted from the manifold 2220 to a display unit 2300 (FIG. 3) and/or a monitoring system 2300′ (FIG. 11), which may be, for example, a monitoring system having various display capabilities, such as a system comprising various mobile devices (e.g., tablets, mobile phones, et cetera), television screens, et cetera. The information shown on the display unit 2300 and/or monitoring system 2300′ may be identical to that shown on the manifold display 2250, or alternately may be other patient specific information (e.g., heart rate, blood pressure, etc.), information regarding the procedure, or any other valuable information.

Determination of the target contrast use and the contrast use limit is based on patient specific information (e.g., age, serum creatinine, sex, race and/or gender, depending upon the method). Upon powering up the manifold 2220, the processor 1010 may cause the programming 1020 to prompt the user to input patient specific data. Patient specific data and/or contrast type may be entered into directly into the manifold 2220 through the use of the input device 1030. Alternately, as will be discussed below, the program 1020 may auto identify the patient specific data from a patient's electronic medical record (EMR).

The input device 1030 may be any device useful for inputting information into the programming 1020. For example, the input device 1030 of the manifold 2220 may be an input button 2262 and/or input selection wheel 2264 located directly on the manifold. Alternately, the manifold display screen 2250 may be, for example, a touchscreen with which a user may input data. Separate input devices 1030′ may be in wireless connection with the electronic manifold 2220 (e.g., a keyboard, handheld device, et cetera) as described above, and may be used to input patient specific data. As described above, the patient specific data may be stored in electronic medical records (EMR) or reporting systems (e.g., Mac-Lab) which the processor 1010 may automatically identify for determination of GFR. It should also be noted that a patient's GFR may be predetermined based on previous blood work. In such instances, the GFR value may additionally be input via the input device 1030 using the various methods described above, which may eliminate the need for calculation of GFR by the manifold 2220.

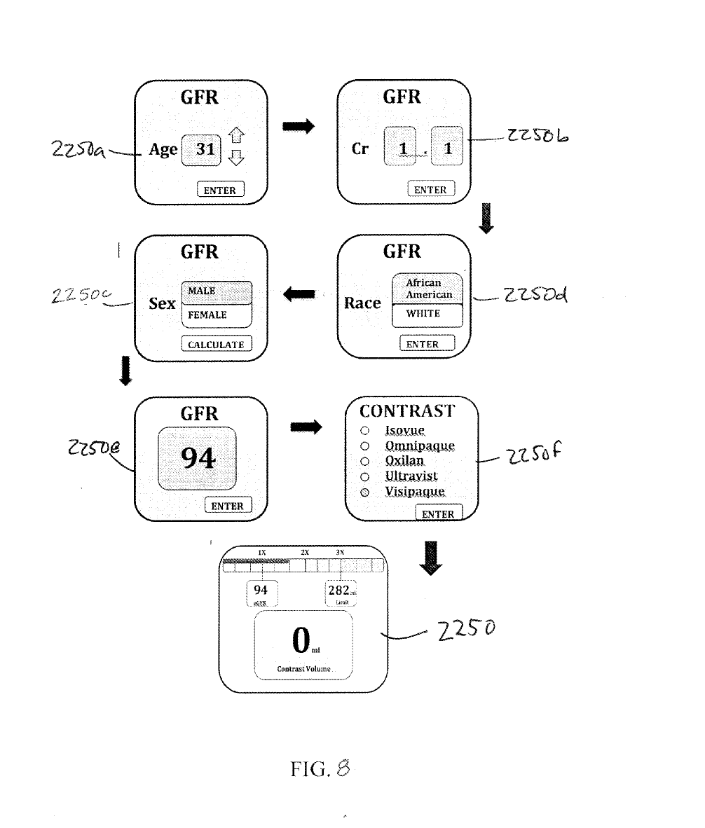

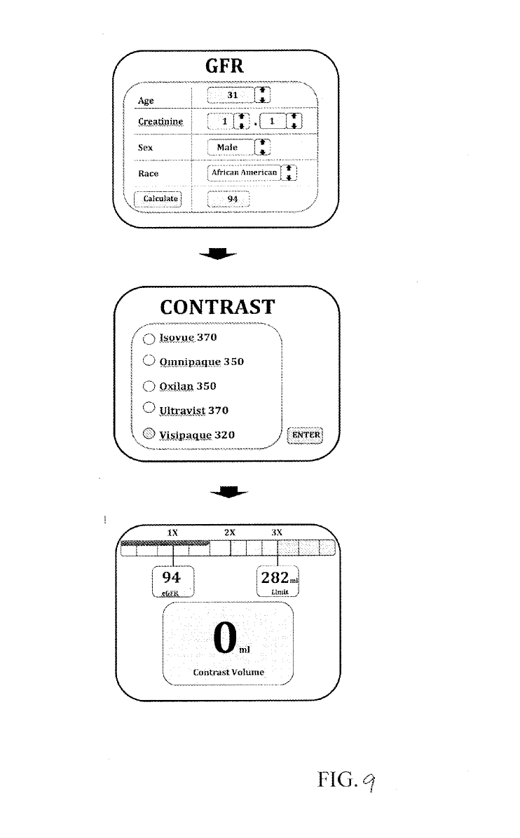

FIGS. 8 and 9 illustrate an example of the electronic manifold display screen 2250 set up. A set sequence of manifold screen images may allow for input of patient specific data and/or contrast type. Data may be input as described above. On successive screens, patient age 2250a, serum creatinine 2250b, race (white of African American) 2250c, and sex (male or female) 2250d may be entered depending upon the chosen model (e.g., Cockcroft-Gault, MDRD, ACC-NCDR, et cetera). Upon receipt of the patient specific data, whether by user input or identification directly from an EMR, the program 1010 may automatically calculate and display 2250e the patient's particular eGFR and/or CrCl for determining the patient's contrast use target and/or limit. Alternately, the user may be required to activate the calculation process by pushing a button on the manifold 2220 or otherwise causing the calculation process to begin. Optionally, the monitor display 2250 (or other input device) may proceed to a screen where the contrast media type may be selected 2250f. The patient's target and limit contrast use may then be displayed on the manifold display 2250 and/or display unit 2300 as described above.

In the event of an emergency, there may not be sufficient time to enter patient specific data or certain information may not be readily available (e.g., serum creatinine) such that the calculation of the patient's GFR is hindered or made impossible. In this case, the manifold 2220 may have an emergency mode wherein the manifold display 2250 presents only the cumulative contrast volume as calculated by the manifold 2220 as described below.

The manifold 2220 may be further equipped with means for determining, in real time, the amount of contrast delivered to a patient. The program 1020 may include instructions for determining the delivered volume of contrast media to the patient by measuring the rate of fluid flow over time to derive the volume using known principles. Commercially available contrast media exists in a range of osmolalities and viscosities. Therefore, a set coefficient may be required for each contrast media type to ensure accurate flow measurements based on the contrast media's chemical and physical properties. The contrast media used for the case may be chosen from a list of commercial available contrast media presented to the user on the manifold display 2250 during the set up (e.g., when the patient specific information is entered) as described above. Alternately, a scanner or camera may be used to scan the contrast bag for identification information.

The programming 1010 may set the default initial amount of contrast media at 0 ml. However, in instances where contrast has already been administered to the patient, such as through performance of left ventriculography or aortography with a power injector, the starting volume can be inputted into the manifold device 2220 either directly or via other available input devices (1300a, 1300b, 1300c).

Instantaneous fluid flow may be measured by any appropriate method, including mechanical flow meters (e.g., a piston meter, gear meter, variable area meter, turbine flow meter, et cetera), pressure based meters (e.g., Venturi meter, Orifice plate, Pitot-Static tube, et cetera), optical flow meters, thermal mass flow meters, vortex flow meters, electromagnetic, ultrasonic, or coriolis flow meters, or any other appropriate method.

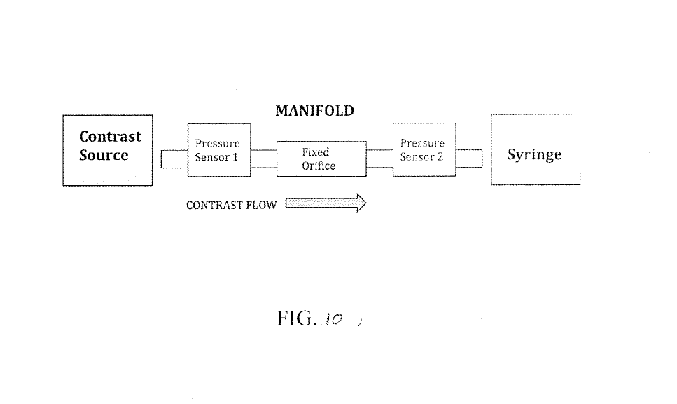

In embodiments, it may be preferable to determine the volume of delivered contrast by measuring the differential pressure across an orifice 2272 (or flow sensor housing 2272) of known dimensions according to the Bernoulli equation. For example, a volume sensor 2274 may be imbedded within the manifold 2220 between the contrast intake port 2270 and the contrast stopcock 2226. The volume sensor 2274 measures contrast volume as it passes into the manifold 2220 and up into syringe 2228 (FIG. 3). The volume sensor 2274 may include at least one pressure sensor 2278 on either side of the orifice 2272. The pressure sensors 2278 may be, for example, piezoresistor wires with pressure sensing capability embedded into the manifold 2220. Thus, as contrast flows across the orifice 2272 within the tubing 2116, the pressure is measured on either side of the orifice 2272 by the electronic pressure sensors and the pressure differential may then be determined, from which the flow rate may be derived. The duration of flow may be obtained by timing the activation of the pressure sensors 2278. The volume of contrast delivered through the manifold 2220 may then be determined from the flow rate and the duration of flow. A flow chart of this exemplary process is illustrated in FIG. 10.

As contrast is delivered to the patient, the manifold 2220 continuously determines the total volume of contrast that has been delivered to the patient, and displays this information on the display screen 2250 and/or the display unit 2300 and monitoring system 2300′ in conjunction with the calculated patient target and/or limit as described above. Thus, the healthcare provider is presented with easy-to-read up-to-date information regarding the amount of contrast delivered to the patient and how it compares to the values that the patient can safely tolerate. While the flow rate of the contrast through the manifold is continuously measured, the total volume of contrast and relating displays may be updated at predetermined intervals, such as every 1/10 of a second, every second, every mL of contrast administered, et cetera.

Measuring the volume at the point of contrast input into the manifold accounts for the requisite waste remaining in the contrast tubing and contrast saver at the completion of each use. The volume of contrast remaining in the syringe (if any) at the completion of the case should be subtracted from the measured total contrast volume for the case to ensure that an accurate final volume is reported. The manifold may also allow for accurate measurement of contrast volume when contrast is mixed with saline from the saline flush line within the syringe, as is typical for performance of digital subtraction angiography.

It should be noted that contrast may be pulled through the manifold as the device is prepped and cleared of air, which may be be measured by the volume sensor 2274. To maintain the accuracy of the contrast volume reading, the contrast volume can be reset to zero prior to the start of the procedure by using the input device (e.g., display input button 2262 and input selection wheel 2264) so that this waste is not counted toward the total procedural volume administered to the patient.

The manifold 2220 may be made of injection molding plastic though those skilled in the art will appreciate that other materials and sizes may be used, however. Additionally, manifold 2220 may generally be sterilizable but is intended for single use only.

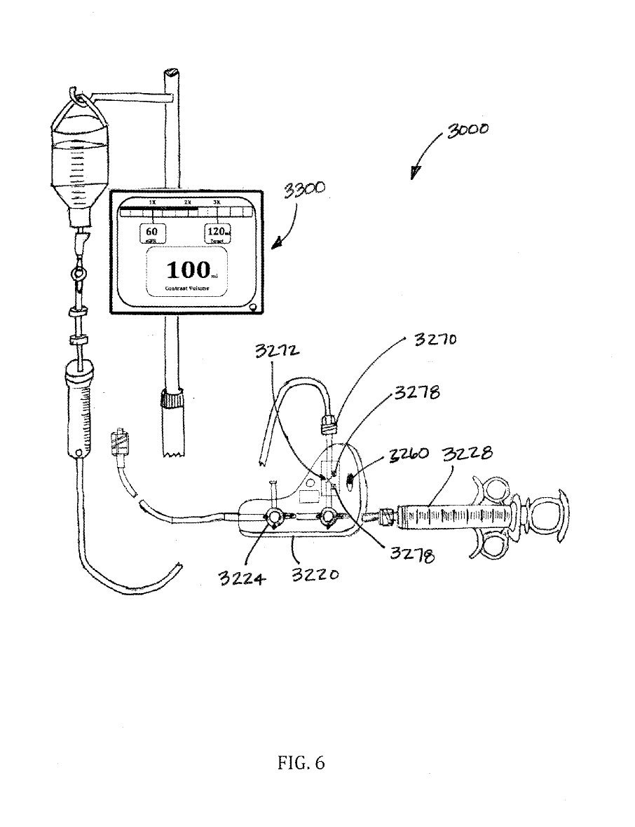

In another embodiment 3000 illustrated in FIG. 6, the data unit 1120 may be an electronic manifold 3220 that is similar to manifold 2220 except as shown and described herein, or as would be understood by one of ordinary skill in the art. As shown in FIG. 6, the manifold 3220 may be capable of completing the delivered volume calculations as described above with respect to embodiment 2000. However, manifold 3220 may not be equipped with a manifold display 2250. Patient specific data may be entered into the display unit 3300 (and/or monitoring system 2300′) according to the methods described above, and the display unit 3300 (and/or monitoring system 2300′) may display the patient's target/limit contrast volumes, a contrast gauge, and the total volume of contrast delivered as described above regarding embodiment 2000.

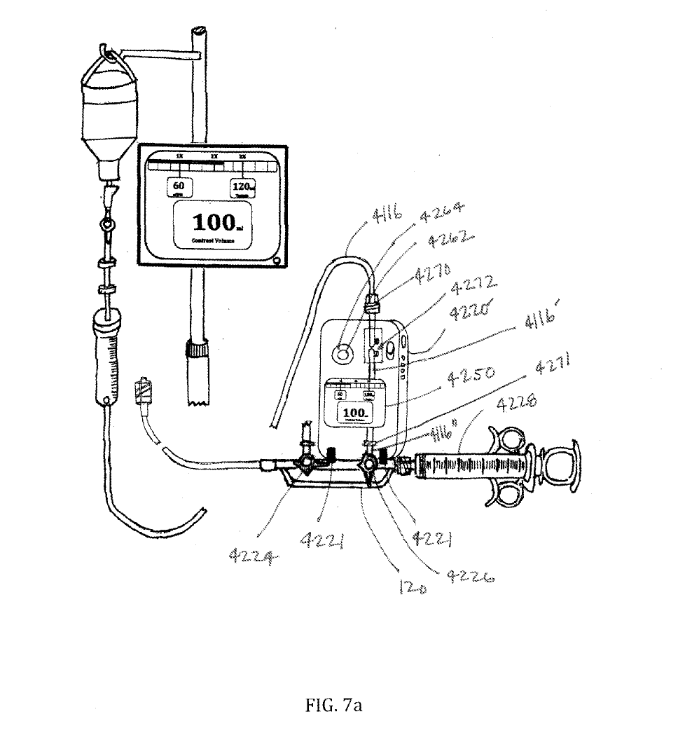

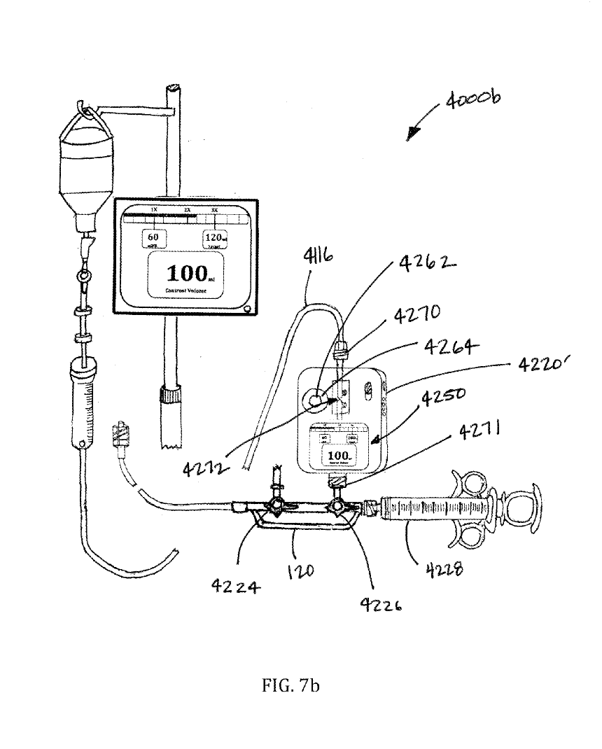

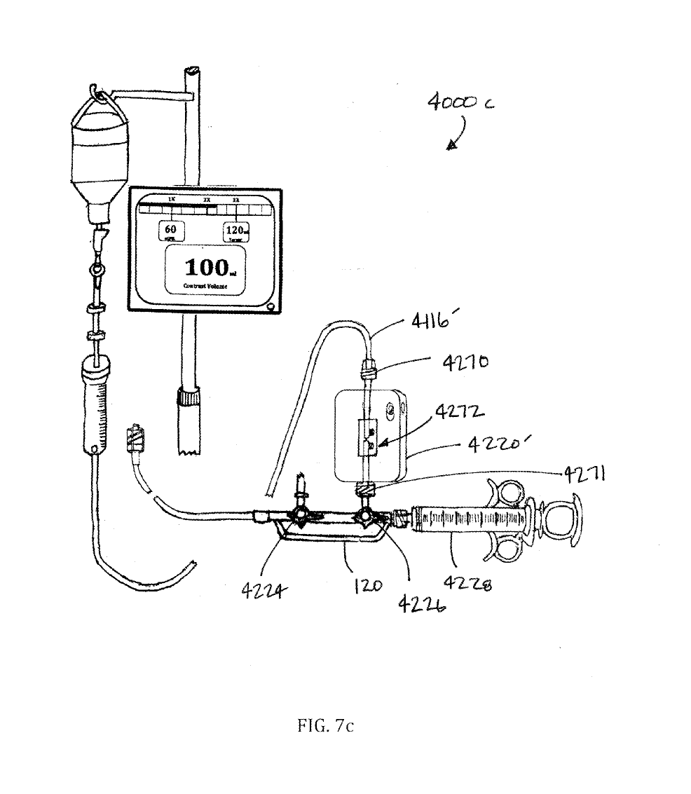

In still another embodiment 4000a, shown in FIG. 7a, a standard manifold 120 may be equipped with a supplemental electronic manifold attachment 4220′. The supplemental manifold attachment 4220′ may releasably attach to the standard manifold 120 via, for example, clips 4221 to hold the attachment 4220′ firmly in place (e.g., as shown in FIG. 7a). Alternatively, the supplemental electronic manifold attachment 4220′ may be small enough to attach to the contrast tubing 4116 on the intake side of the device and to the standard manifold 120 via its luer lock 4271 as shown in embodiment 4000b (FIG. 7b) and embodiment 4000c (FIG. 7c). The contrast tubing 4116 may connect to tubing 4116′ running through the manifold attachment 4220′ and connected to the manifold tubing 4116″ such that stopcock 4226 may operate to pull contrast through the manifold 120 according to traditional manifold operation procedures.

The manifold attachment 4220′ may be equipped with a manifold display 4250 as illustrated in FIGS. 7a and 7b. The manifold display 4250 may be substantially similar manifold display 2250, described above. Alternately, the manifold attachment 4220′ may not have a manifold display (FIG. 7c), in which the manifold attachment 4220′ may be substantially similar to manifold 3220, except that the manifold attachment 4220′ may be removable from the manifold 120.

The manifold 2220, 3220, supplemental manifold attachment 4220, display unit 2300, 3300, and monitoring system 2300 may be powered by any acceptable means. For example, power may be derived from fluid flow, or the devices may be powered externally by an external light source, an electrical or mechanical connection, or an internal power source. Non-limiting examples of internal power sources include single-use batteries and rechargeable batteries (e.g., lithium-poly or lithium-ion batteries). Additionally, the system may be powered by mechanical means of storing power, such as a spring that stores energy. It shall be understood that it may be preferable for the power source to provide power for approximately 6 to 12 hours to easily accommodate even very lengthy interventional procedures.

The invention may be further understood as part of a non-limiting example with reference to FIG. 11, which illustrates one typical configuration of a cardiac catheterization laboratory incorporating the electronic manifold 2220, a handheld device 1300a, a mounted monitor display unit 1300b, a cath lab monitor 1300c, and a catheterization lab hemodynamic and reporting system 2300′. In use, the manifold display screen 2250 is turned on. The manifold 2220 may then seek out wireless connections with other available input and/or output devices (e.g., 1300a, 1300b, 1300c) in the lab suite, as well as devices outside of the suite, such as computers on the network (not shown). The handheld device 1300a may be used to set up the manifold device 2220 wirelessly prior to the onset of the procedure.

Information input may be accomplished by healthcare personnel that are not scrubbed into the procedure. Alternately, the patient data may be input into the manifold via the manifold display 2250 (FIG. 4), mounted monitor display unit 1300b, or any other appropriate means. As described in detail above, the manifold display may be linked wirelessly (or through a wired connection) to a mounted monitor display unit 1300b to display real time contrast volume used and the contrast gauge relative to the patient's determined renal function. Data from the manifold may be sent to any output device 1300a, 1300b, 1300c wirelessly or through wired transmission.

While the embodiments described herein measure the volume of contrast media delivered to a patient for coronary and peripheral vascular angiographic and interventional procedures in real time, the described flow meter may also find use in other applications. For example, the flow meter may be used, among other things, to measure flow in other clinical situations including urine output and wound and/or chest tube drainage. Similar to the other described embodiments, data regarding urine output or chest tube drainage may be displayed on a bedside monitor or wirelessly input into an electronic medical record or patient monitoring system.

Many different arrangements are possible without departing from the spirit and scope of the present invention. Embodiments of the present invention are described herein with the intent to be illustrative rather than restrictive. Alternative embodiments will become apparent to those skilled in the art that do not depart from its scope. A skilled artisan may develop alternative means of implementing the disclosed improvements without departing from the scope of the present invention. Further, it will be understood that certain features and subcombinations are of utility and may be employed without reference to other features and subcombinations and are contemplated within the scope of the claims. Not all steps listed in the various figures and description need be carried out in the specific order described. The description should not be restricted to the specific described embodiments.

1. A system for monitoring an amount of contrast media administered to a patient, comprising:
an electronic manifold having a processor in data communication with non-transitory computer memory, programming, a first input device, and a first output device, the electronic manifold comprising:
a contrast media intake port; and
a volume sensor;
wherein the programming includes instructions for:
(a) receiving patient specific data and contrast media data;
(b) calculating a patient's renal function;
(c) determining at least one of a contrast volume target and a contrast volume limit based on the patient's renal function;
(d) calculating the total volume of contrast media flowing through the manifold; and
(e) displaying the contrast volume data on the first output device.

2. The system of claim 1, wherein the first output device is a display screen located on the manifold.

3. The system of claim 2, further comprising a second output device in data communication with the electronic manifold, wherein a display of the second output device is identical to the first output device.

4. The system of claim 1, wherein the volume sensor measures the flow rate of contrast media through the manifold in real time, thereby allowing the programming to calculate the total volume of contrast media delivered to the patient in real time, and wherein the first output device continuously updates the contrast volume data.

5. The system of claim 4, wherein the programming further includes instructions for:
(f) providing an alert when the total contrast media volume reaches at least one of the contrast volume target and the contrast volume limit.

6. The system of claim 6, wherein the alert is at least one of auditory and haptic.

7. The system of claim 1, wherein the first input device comprises an input button and an input selection wheel.

8. The system of claim 7, further comprising a second input device, wherein the second input device is in wireless communication with the electronic manifold and is selected from the list consisting of: a keyboard, a smartphone, a dedicated mounted display, and a tablet computer.

9. The system of claim 1, wherein the first input device and the first output device are combined as a single manifold display, and wherein the manifold display is a touchscreen for inputting patient specific data.

10. The system of claim 1, wherein the patient specific information is automatically retrieved from at least one patient database.

11. The system of claim 10, wherein the patient specific information includes at least three of the patient's age, weight, serum creatinine, race, and sex.

12. The system of claim 11, wherein the patient's renal function is determined based on a MDRD equation.

13. The system of claim 11, wherein the patient's renal function is determined based on a Cockcroft-Gault equation.

14. A system for measuring an amount of delivered contrast media volume to a patient, comprising:
a manifold;
an electronic manifold attachment removably attached to the manifold, comprising:
a flow meter; and
an electronic element, comprising:
a processor;
non-transitory computer memory; and
programming; and
an input device in communication with the electronic manifold attachment;
wherein the flow meter measures the flow rate of contrast media through the manifold during a procedure; and
wherein the programming includes instructions for:
(a) calculating a patient's estimated renal function based on patient specific data input;
(b) determining a contrast volume target and a contrast volume limit based on the patient's estimated renal function;
(c) calculating the total volume of contrast through the manifold based on the flow rate; and
(d) communicating the volume of fluid through the manifold, the contrast volume target, and the contrast volume limit.

15. The system of claim 14, wherein:
the communicating includes communicating for display;
the display includes a contrast gauge; and
the contrast gauge provides a visual representation of the total volume of fluid through the manifold in relation to the patient's determined contrast volume target and contrast volume limit.

16. The system of claim 15, wherein a speaker in communication with the electronic manifold attachment sounds an alarm when the total volume of fluid through the manifold reaches the patient's determined contrast volume target and contrast volume limit.

17. The system of claim 14, wherein the flow rate is dependent upon the media contrast type, and wherein the media contrast type is selected from a list provided to the user via the input device.

18. The system of claim 15, wherein, at the conclusion of the procedure, the total contrast volume as determined by the electronic manifold attachment is automatically transmitted to a patient database and stored in the patient's electronic medical chart.

19. A system for measuring contrast media volume, comprising:
a manifold having a volume sensor attached thereto;
an input device; and
an output device;
wherein:
the input device and the output device are in communication with the volume sensor;
patient specific data is entered into the system via the input device and displayed via the output device;
the volume sensor determines the volume of contrast media through the manifold; and
the volume of contrast delivered to the patient is displayed on the output device substantially simultaneously with a predetermined target amount of contrast media for the patient.

20. The system of claim 19, wherein the predetermined target amount of contrast for the patient is based on the patient specific data, and wherein the patient specific data includes the patient's estimated renal function.
